(19) United States
(12) Patent Application Publication
(10) Pub. No.: US 2025/0159097 A1
(43) Pub. Date: May 15, 2025

(54) VIDEO DISPLAYING APPARATUS, VIDEO PROCESSING SYSTEM, AND VIDEO PROCESSING METHOD

(71) Applicant: SONY SEMICONDUCTOR SOLUTIONS CORPORATION, KANAGAWA (JP)

(72) Inventor: KOTA YONEZAWA, KANAGAWA (JP)

(21) Appl. No.: 18/838,793

(22) PCT Filed: Feb. 6, 2023
(86) PCT No.: PCT/JP2023/003706

§ 371 Date: Aug. 15, 2024

(30) Foreign Application Priority Data
Feb. 24, 2022 (JP) 2022-026322

(51) Int. Cl. H04N 5/222; G06T 7/73

(52) U.S. Cl. CPC H04N 5/2224; G06T 7/73; G06T 2207/10016; G06T 2207/30244

(57) ABSTRACT

The present technology relates to a video displaying apparatus, a video processing system, and a video processing method by which the estimation accuracy of a position posture of a camera that shoots a video to be displayed as the background is improved. A virtual production system estimates a position posture of a camera, with use of distance measurement data acquired from a sensor. The camera shoots a video to be displayed on a video displaying unit on a background. The video displaying unit includes a plurality of pixels in each of which a light source is arranged, and absorbs light of a predetermined wavelength at a light absorbing region that is at least part of a region, other than the light source, of a light absorbing pixel that is at least part of the plurality of pixels. Then, the virtual production system generates, on the basis of a result of the estimation of the position posture, video data that associates the position of the camera in a shooting space and the position of the camera in the video with each other, and outputs the generated video data to the video displaying unit. The present technology can be applied to a virtual production system.

### TECHNICAL FIELD

The present technology relates to a video displaying apparatus, a video processing system, and a video processing method, and particularly to a video displaying apparatus, a video processing system, and a video processing method which enhance the estimation accuracy of a position posture of a camera that shoots a video to be displayed as the background.

### BACKGROUND ART

In virtual production (Virtual Production) that has recently begun to attract attention, it is necessary to generate a video as viewed from a point of view of a camera in real time and display the video on an LED (Light Emitting Diode) display on the back side, and therefore, estimation of the position posture of the camera is one of the most significant technologies.

In contrast, conventionally, a system that performs estimation of a position posture of a camera with use of an IR (Infrared Rays) or RGB camera has already been utilized, and, in recent years, a method for performing estimation of a position posture of a camera with use of LiDAR (Light Detection And Ranging) has been examined.

On the other hand, in an algorithm for estimation of a self-position posture (referred to sometimes as a localization) by the LiDAR, the shape of a surrounding three-dimensional object (hereinafter referred to as three-dimensional shape) is acquired and is matched with map information acquired in advance to perform estimation of the self-position posture. Therefore, if three-dimensional objects having a size capable of being captured by the LiDAR are not present sufficiently, then the characteristic shape attributable to a point cloud becomes poor, and therefore, the degree of accuracy of matching lowers, and it is difficult to estimate a self-position posture correctly.

Accordingly, for example, in a case where the FOV (Field Of View) of the LiDAR is small and the number of three-dimensional objects is small in a shooting site, estimation of the position posture of the camera is likely to fail.

It is to be noted that a technology is disclosed in PTL 1 in which a portion that absorbs infrared rays and another portion that reflects infrared rays are provided in a target apparatus for adjusting the sensor axis of the LiDAR incorporated in a vehicle.

### CITATION LIST

### Patent Literature

[PTL 1]
JP 2021-085679A

### SUMMARY

### Technical Problem

However, since a shooting studio is a site of video production, “to add a three-dimensional object” for the position posture estimation of a camera is not always possible. Since, especially in a studio for virtual production, an LED display is arranged in a planar or cylindrical shape, three-dimensional characteristics for estimation of a self-position posture by the LiDAR are poor. As a result, it is concerned that an error of an estimation result of a position posture of a camera is increased.

The present technology has been made in view of such a situation as described above, and contemplates improvement of the estimation accuracy of a position posture of a camera that shoots a video to be displayed as the background.

### Solution to Problem

A video displaying apparatus of one aspect of the present technology includes a plurality of pixels in each of which a light source is arranged, in which light of a predetermined wavelength is absorbed at a light absorbing region that is at least part of a region, other than the light source, of a light absorbing pixel that is at least part of the plurality of pixels.

A video processing system of another aspect of the present technology includes a video displaying unit that includes a plurality of pixels in each of which a light source is arranged and that absorbs light of a predetermined wavelength at a light absorbing region that is at least part of a region, other than the light source, of a light absorbing pixel that is at least part of the plurality of pixels, a camera that shoots a video to be displayed on the video displaying unit on a background, a position posture estimation unit that estimates a position posture of the camera with use of distance measurement data acquired from a sensor, and a video generation unit that generates, on the basis of a result of the estimation of the position posture, video data that associates the position of the camera in a real space and the position of the camera in the video with each other, to output the generated video data to the video displaying unit.

In the one aspect of the present technology, the light of the predetermined wavelength is absorbed at the light absorbing region that is at least part of a region, other than the light source, of a light absorbing pixel that is at least part of the plurality of pixels in which the light source is arranged.

In another aspect of the present technology, the video displaying unit absorbs the light of the predetermined wavelength at the light absorbing region that is at least part of the region, other than the light source, of the light absorbing pixel that is at least part of the plurality of pixel in each of which the light source is arranged. Then, the position posture of the camera, which shoots a video to be displayed on the video displaying unit on the background, is estimated with use of distance measurement data acquired from the sensor, and video data that associates the position of the camera in the real space and the position of the camera in the video with each other is generated on the basis of a result of the estimation of the position posture. Then, the generated video data is outputted to the video displaying unit.

### BRIEF DESCRIPTION OF DRAWINGS

FIG. 1 is a view depicting a configuration of an appearance of an embodiment of a virtual production system to which the present technology is applied.

FIG. 2 is a view depicting an example of a detailed configuration of the virtual production system.

FIG. 3 is a block diagram depicting an example of a functional configuration of a camera tracking device.

FIG. 4 is a view depicting contents of processing of localization.

FIG. 5 is a view depicting an example of a configuration of an LED display.

FIG. 6 depicts views illustrating an example of a point cloud of pre-map data or input point cloud data.

FIG. 7 is a view depicting an example of an infrared absorbing material sheet.

FIG. 8 is a view depicting a first example of an arrangement pattern of an infrared absorbing region.

FIG. 9 is a flow chart illustrating processing of the virtual production system.

FIG. 10 is a flow chart illustrating a calculation process of position posture information of a shooting camera in step S32 in FIG. 9.

FIG. 11 is a flow chart illustrating a pre-process by the camera tracking device.

FIG. 12 depicts views illustrating second and third examples of an arrangement pattern of an infrared absorbing region.

FIG. 13 depicts views illustrating fourth and fifth examples of an arrangement pattern of an infrared absorbing region.

FIG. 14 depicts views illustrating sixth and seventh examples of an arrangement pattern of an infrared absorbing region.

FIG. 15 depicts views illustrating eighth and ninth examples of an arrangement pattern of an infrared absorbing region.

FIG. 16 is a block diagram depicting an example of a configuration of a computer.

### DESCRIPTION OF EMBODIMENTS

In the following, an embodiment for carrying out the present technology is described. The description presents information to be given in the following order.
1. Embodiment (Virtual Production System)
2. Modification
3. Others

### 1. Embodiment

### <Example of Configuration of Appearance of Virtual

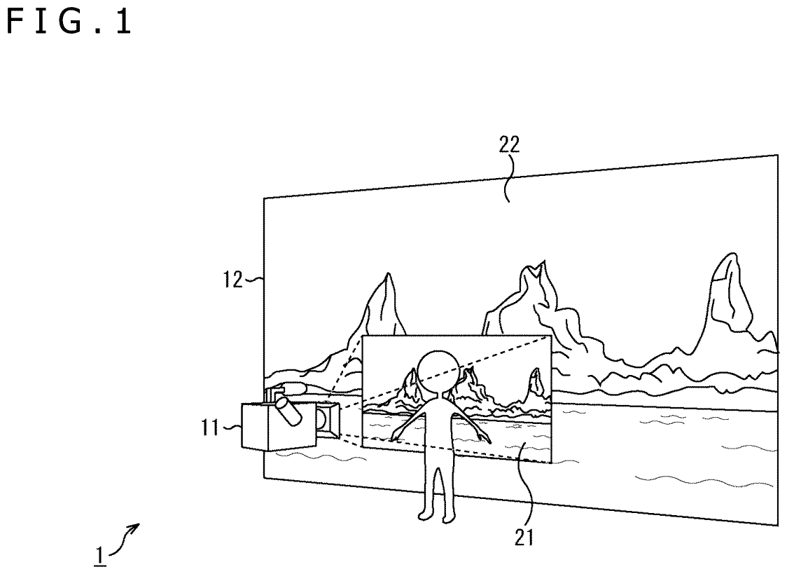

FIG. 1 is a view depicting an example of a configuration of an appearance of an embodiment of a virtual production system to which the present technology is applied.

### Production System>

The virtual production system 1 of FIG. 1 is provided at a shooting site such as, for example, an indoor shooting studio.

The virtual production system 1 is a system that generates a video as viewed from a point of view of a shooting camera 11 in real time during shooting of a live-action video and that displays the video on an LED display 12 on the back side, namely, a system that performs in-camera VFX (Visual Effects). It is to be noted that, though not depicted, an LED display is sometimes arranged also on the ceiling or a side wall of the shooting studio.

The shooting camera 11 shoots a background video including a set of performers in the foreground and the background, CG (Computer Graphics) to be displayed on the LED display 12, or the like.

On the LED display 12, an inner frustum 21 and an outer frustum 22 are displayed.

The inner frustum 21 is a video-in-video content displayed on the LED display 12 and represents a field of view (FOV) from the point of view of the shooting camera 11 with reference to a focal distance of the lens at present.

In particular, the inner frustum 21 is a portion actually shot by the shooting camera 11 and includes, for example, a 4K high definition video. In a case where the shooting camera 11 itself moves to the right while it is shooting the inner frustum 21, a set of the background or a left side of a background video is reflected on the inner frustum 21.

The outer frustum 22 is content that is displayed around the inner frustum 21 on the LED display 12 and is used as a light source for dynamic light and reflection for an actual set. In particular, the outer frustum 22 includes a video for ambient light with a lower degree of accuracy of a video than that required by the inner frustum 21.

In such a virtual production system 1 as described above, it is necessary for the inner frustum 21 to operate in an interlocked relation with the position posture of the shooting camera 11, and estimation of the position posture of the shooting camera 11 is one of the most significant technologies.

### <Detailed Configuration of Virtual Production System>

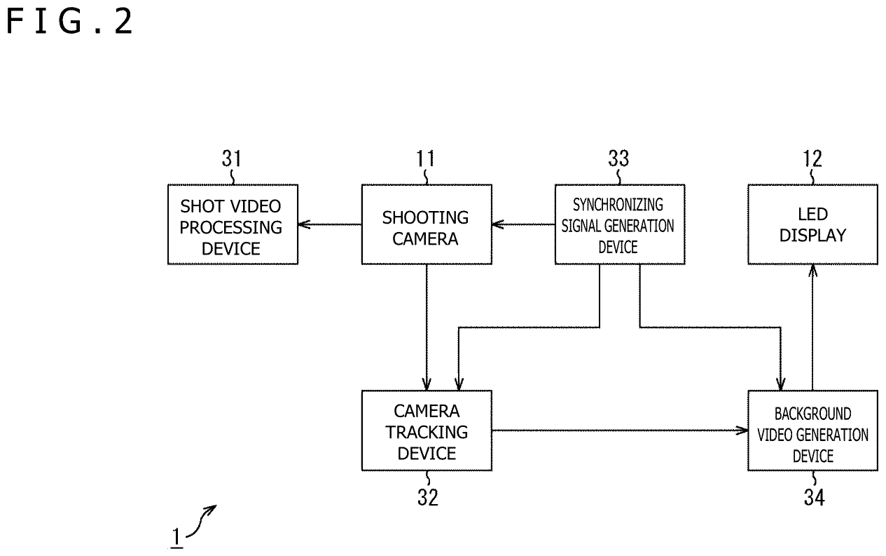

FIG. 2 is a view depicting an example of a detailed configuration of the virtual production system of FIG. 1.

In FIG. 2, the virtual production system 1 is configured from the shooting camera 11 and the LED display 12 of FIG. 1, a shot video processing device 31, a camera tracking device 32, a synchronizing signal generation device 33, and a background video generation device 34.

The shot video processing device 31 displays or stores a video shot by the shooting camera 11 into a storage.

The camera tracking device 32 is mounted on the shooting camera 11. The camera tracking device 32 performs localization (estimation of the self-position posture) with use of distance measurement data obtained by measurement of a distance, to acquire an estimation result of the position posture of the shooting camera 11. The camera tracking device 32 outputs the estimation result of the position posture of the shooting camera 11 as camera tracking metadata to the background video generation device 34.

The synchronizing signal generation device 33 generates a synchronizing signal for performing time synchronization of the entire system. The synchronizing signal generation device 33 outputs the generated synchronizing signal to the shooting camera 11, the camera tracking device 32, and the background video generation device 34.

The shooting camera 11, the camera tracking device 32, and the background video generation device 34 individually generate a corresponding video on the basis of the synchronizing signal supplied from the synchronizing signal generation device 33.

The background video generation device 34 links a positional relation in a real space of a real shooting studio and a positional relation in the CG on the basis of the camera tracking metadata supplied from the camera tracking device 32, to generate a background video serving as the inner frustum 21 and another background video serving as the outer frustum 22. The background video generation device 34 outputs the generated inner frustum 21 and outer frustum 22 to the LED display 12.

### <Functional Configuration of Camera Tracking Device>

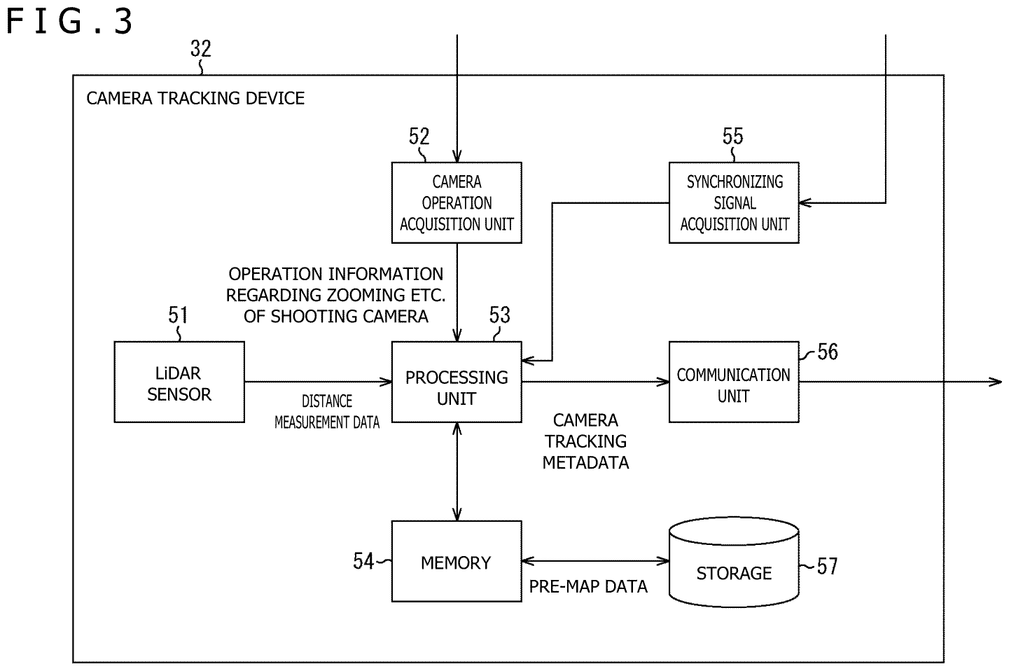

FIG. 3 is a block diagram depicting an example of a functional configuration of the camera tracking device 32 of FIG. 2.

In FIG. 3, the camera tracking device 32 is configured from a LiDAR sensor 51, a camera operation acquisition unit 52, a processing unit 53, a memory 54, a synchronizing signal acquisition unit 55, a communication unit 56, and a storage 57.

The LiDAR sensor 51 is a LiDAR sensor including a light emitting unit of infrared light. The LiDAR sensor 51 emits infrared light at every fixed interval of time to acquire distance measurement data and outputs the acquired distance measurement data to the processing unit 53.

The camera operation acquisition unit 52 acquires operation information of zooming or the like of the shooting camera 11 of a tracking target. The camera operation acquisition unit 52 outputs the acquired operation information to the processing unit 53.

The processing unit 53 reads in pre-map data generated in advance from the storage 57 and develops the pre-map data in the memory 54. The processing unit 53 processes the distance measurement data supplied from the LiDAR sensor 51 to generate input point cloud data.

The processing unit 53 converts the distance measurement data supplied from the LiDAR sensor 51 to generate input point cloud data. The processing unit 53 performs localization with use of the pre-map data developed in the memory 54 and the input point cloud data, to acquire an estimation result of the self-position posture.

The processing unit 53 generates camera tracking metadata on the basis of the camera operation information supplied from the camera operation acquisition unit 52, the synchronizing signal supplied from the synchronizing signal acquisition unit 55, and the acquired estimation result of the self-position posture. The processing unit 53 outputs the generated camera tracking metadata to the communication unit 56.

The camera tracking metadata includes information of a position, a posture, a height, an angle, and so forth of the shooting camera 11.

It is to be noted that the pre-map data is generated in advance by another information processing apparatus or the like with use of distance measurement data from a 3D scanner type three-dimensional measuring instrument, and either is acquired via a network through the communication unit 56 or is stored into the storage 57 through a storage medium such as an SD card. However, the processing unit 53 itself may be configured so as to have a pre-map data generation function therein.

The memory 54 reads the pre-map data and other types of data stored in the storage 57 and develops the pre-map data or the like or stores the pre-map data into the storage 57 under the control of the processing unit 53.

The synchronizing signal acquisition unit 55 acquires the synchronizing signal supplied from the synchronizing signal generation device 33 and outputs the synchronizing signal to the processing unit 53.

The communication unit 56 transmits the camera tracking metadata supplied from the processing unit 53 to the background video generation device 34.

The storage 57 stores data, a program, and so forth under the control of the processing unit 53.

### <Localization>

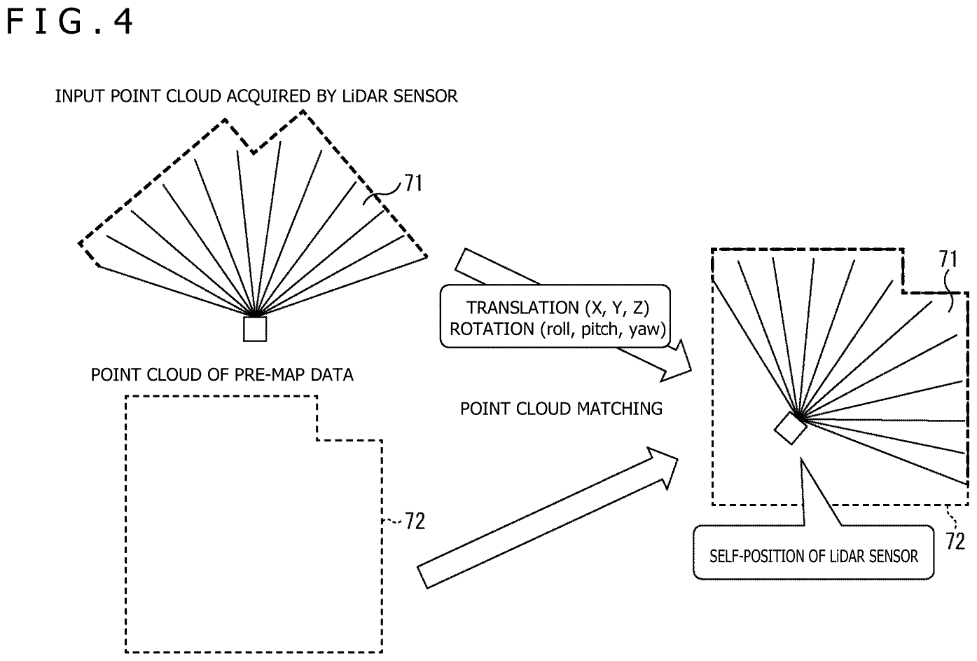

FIG. 4 is a view depicting contents of processing of localization.

On the left side in FIG. 4, a point cloud 71 and another point cloud 72 are depicted.

The point cloud 71 represents a point cloud of input point cloud data generated on the basis of the distance measurement data acquired by the LiDAR sensor 51.

The point cloud 72 represents a point cloud of the pre-map data.

In the localization, point cloud matching of matching the point cloud 71 and the point cloud 72 is performed to determine parameters (translation (X, Y, Z) and rotation (roll, pitch, yaw)) with which they can be aligned exactly with the advance map. This makes it possible to perform estimation of the self-position and posture of the LiDAR sensor 51.

In this manner, in the localization for which the LiDAR sensor 51 is used, a three-dimensional shape in the shooting studio is acquired and matched with the advance map acquired in advance to perform estimation of the self-position posture.

Therefore, if a three-dimensional object of a size sufficient to be grasped by the LiDAR sensor 51 to be used is not sufficiently present, then characteristic shapes attributable to a point cloud are poor, and therefore, the degree of accuracy in matching degrades, making it difficult to estimate the self-position posture correctly.

However, since the shooting studio is a site for video production, it is not always possible to “add a three-dimensional object” for the position posture estimation of the camera. Especially, in a site of the virtual production system 1, the LED display 12 is frequently arranged in a planar shape or a cylindrical shape, and therefore, three-dimensional characteristics for estimation of a self-position posture by the LiDAR are poor. As a result, it is a concern that this may increase errors of an estimation result of the position posture of the camera.

Therefore, as described below, the present technology uses an infrared absorbing material in the LED display 12.

### <Configuration of LED Display>

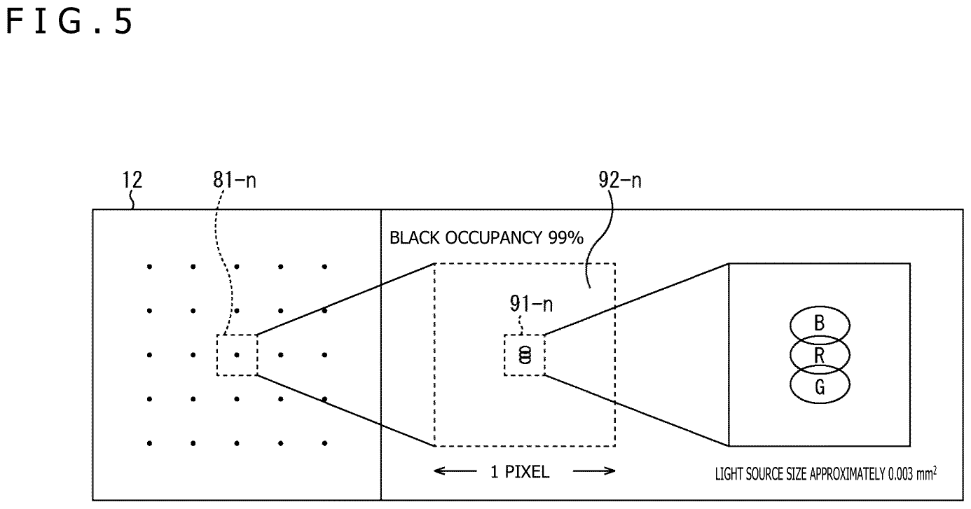

FIG. 5 is a view depicting an example of a configuration of the LED display.

In FIG. 5, part of the LED display 12 is depicted.

Since the area occupied by an LED light source 91-n in one pixel 81-n of the LED display 12 is considerably small (in the case of FIG. 5, approximately 0.003 mm²), at least a region 92-n other than the LED light source 91-n in one pixel is configured from an infrared absorbing material that absorbs light emitted from the LiDAR sensor 51 to change the characteristics in reflection and absorption of infrared light.

As a method for configuring the region 92-n from an infrared absorbing material, a method of pasting an infrared absorbing material sheet or the like to the region 92-n is available.

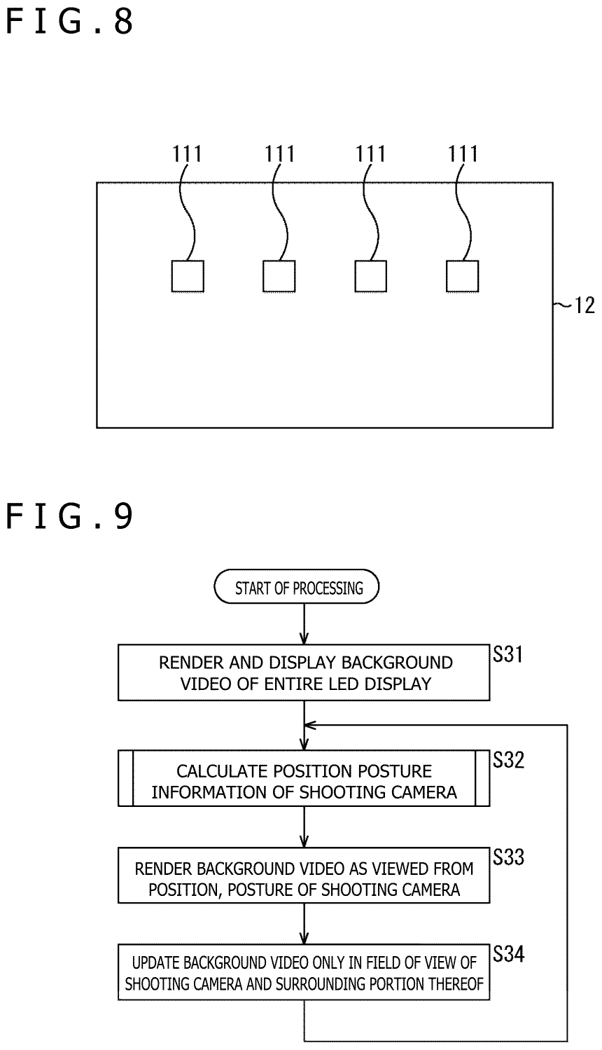

It is to be noted that the region 92-n may not be configured from an infrared absorbing material in all pixels 81-n in the overall area of the LED display 12. For example, an infrared absorbing material sheet may be pasted to the region 92-n only of each of pixels 81-n in an upper half, a horizontal half, or a predetermined region of the LED display 12, or an infrared absorbing material sheet or the like may be pasted to the region 92-n only of each of pixels 81-n included in infrared absorbing regions that are arranged (set) so as to make a particular pattern as depicted in FIG. 8 described later. With use of the infrared absorbing sheet in this manner, the position of the infrared absorbing region can be changed.

As described above, with the configuration that the region 92-n includes an infrared absorbing material, it is possible to change a manner in which a point cloud looks with infrared light of the LiDAR sensor 51 (namely, the position of the presence of the point cloud).

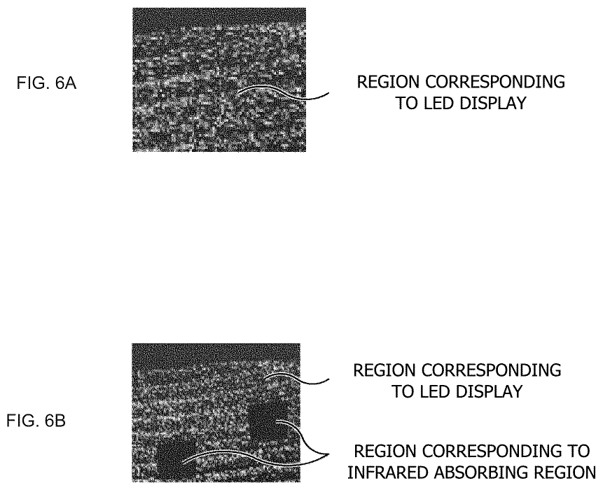

FIG. 6 depicts a view depicting an example of a point cloud of pre-map data or input point cloud data.

A of FIG. 6 is a view depicting a region in a point cloud corresponding to the conventional LED display 12. Meanwhile, B of FIG. 6 is a view depicting a region in a point cloud corresponding to the LED display 12 according to the present technology.

More specifically, in the conventional LED display 12 in which the region 92-n does not include an infrared absorbing material, since the LED display 12 in the shooting studio does not have a characteristic three-dimensional shape, in the pre-map data or the input point cloud data, a point cloud is present all over the region corresponding to the LED display 12 as depicted in A of FIG. 6.

In contrast, for example, in the present technology, the region 92-n of the pixel 81-n included in the infrared absorbing material region described hereinabove in the LED display 12 includes an infrared absorbing material.

With this configuration, as depicted in B of FIG. 6, pre-map data and input point cloud data are put into a state in which, although a point cloud is present in a region corresponding to a region other than the region 92-n of the pixel 81-n included in the infrared absorbing region of the LED display 12, a point cloud is not present in a region (a rectangular region in B of FIG. 6) corresponding to the region 92-n of the pixel 81-n included in the infrared absorbing region of the LED display 12.

Accordingly, matching the pre-map data with the input point cloud data is performed by collating infrared absorbing regions of the LED displays 12 of the relevant pieces of data in which a point cloud is not present with each other, so that the matching is more simplified, and the degree of accuracy in matching can be improved.

It is to be noted that the method of arranging an infrared absorbing region so as to make a particular pattern is more effective in a case where the LiDAR sensor 51 from which a high density point cloud is obtained is used.

### <Infrared Absorbing Material Sheet]

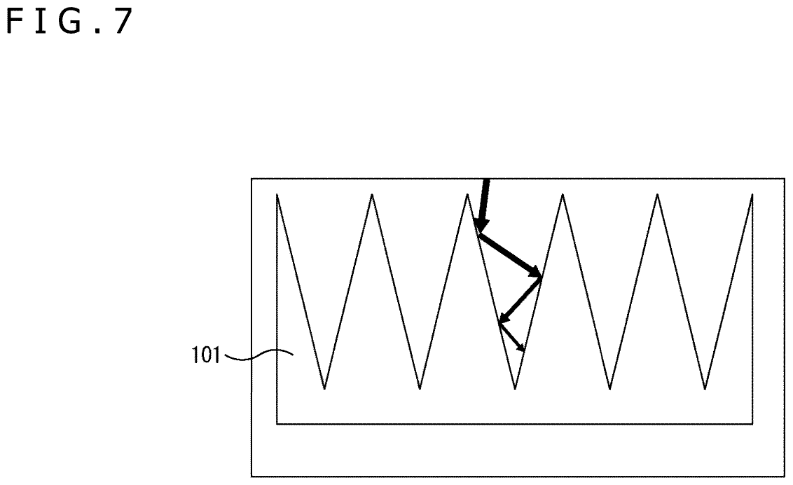

FIG. 7 is a view depicting an example of an infrared absorbing material sheet.

For example, the infrared absorbing material sheet 101 has minute irregularities formed on the surface thereof, and reflection and absorption of infrared rays repeatedly occur at the recessed portions as depicted in FIG. 7, and then, the light is weakened and is finally absorbed.

### <First Arrangement Pattern of Infrared Absorbing Region>

FIG. 8 is a view depicting an example of a first arrangement pattern of an infrared absorbing region.

In FIG. 8, an example is depicted in which an infrared absorbing region 111 including four rectangular regions is arranged in a horizontal row in the LED display 12.

As described hereinabove, an infrared absorbing material sheet is pasted to the portion 92-n of the pixels 81-n included in the infrared absorbing region 111.

It is to be noted that FIG. 8 depicts an example in a case where the resolution of the LiDAR sensor 51 is not very high, and in a case where the resolution of the LiDAR sensor 51 is high, a finer arrangement pattern may be used such that the arrangement pattern of FIG. 8 is scaled down and repeated.

In this manner described above, the pre-map data and the point cloud data acquired from the LiDAR sensor 51 include point clouds other than the infrared absorbing region 111. In particular, since no point cloud is included in the infrared absorbing region 111, even if a three-dimensional object is not present for position posture estimation of the camera in the space of the shooting studio, matching between the relevant pieces of data can be performed by collating regions of the relevant pieces of data corresponding to the infrared absorbing region 111 in which no point cloud is present with each other, and therefore, localization can be performed simply.

### <Processing of System>

FIG. 9 is a flow chart illustrating processing of the virtual production system 1.

In step S31, the background video generation device 34 renders a background video of the overall area of the LED display 12 (namely, a background video that serves as the outer frustum 22) and displays the background video on the LED display 12.

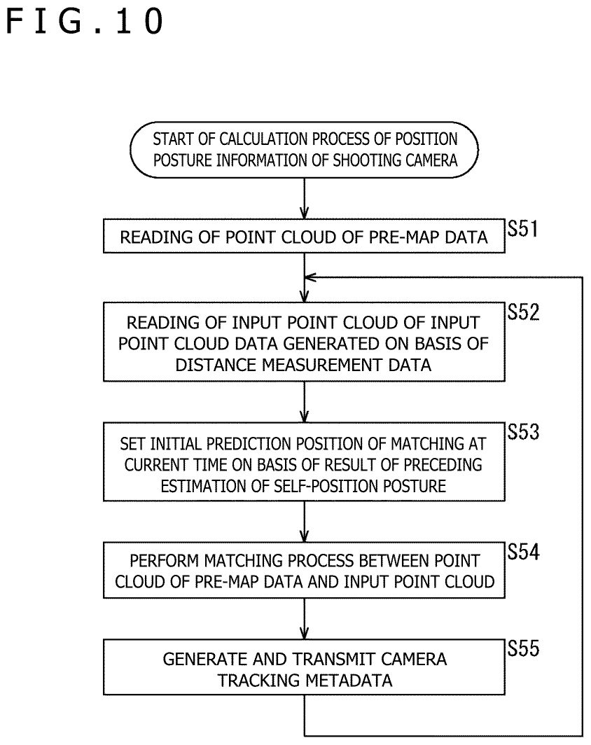

In step S32, the camera tracking device 32 calculates position posture information regarding the shooting camera 11. The calculation process of position posture information regarding the shooting camera 11 is hereinafter described with reference to FIG. 10. Through execution of the process in step S32, camera tracking metadata of the shooting camera 11 is supplied to the background video generation device 34.

In step S33, the background video generation device 34 renders, on the basis of the camera tracking metadata supplied from the camera tracking device 32, a background video only in the field of view of the shooting camera 11 as viewed from the latest camera position and posture (namely, a background video that serves as the inner frustum 21).

In step S34, the LED display 12 updates the background video only in the field of view of the shooting camera 11 and a surrounding portion thereof.

After step S34, the processing returns to step S32, and the subsequent processes are repeated.

### <Calculation Process of Position Posture Information>

FIG. 10 is a flow chart illustrating the calculation process regarding position posture information of the shooting camera 11 in step S32 of FIG. 9.

It is to be noted that processes in steps S51 to S54 of FIG. 9 are the localization process described hereinabove with reference to FIG. 4.

In step S51, the memory 54 reads and develops the pre-map data from the storage 57 under the control of the processing unit 53.

In step S52, the processing unit 53 reads input point clouds of the input point cloud data generated on the basis of the distance measurement data supplied from the LiDAR sensor 51.

In step S53, the processing unit 53 sets an initial prediction position for current matching on the basis of the preceding estimation result of the self-position posture.

In step S54, the processing unit 53 performs a matching process between the point clouds of the pre-map data developed in the memory 54 and the input point clouds to acquire an estimation result of the self-position posture.

In step S55, the processing unit 53 generates camera tracking metadata on the basis of the camera operation information supplied from the camera operation acquisition unit 52, the synchronizing signal supplied from the synchronizing signal acquisition unit 55, and the acquired estimation result of the self-position posture. The processing unit 53 transmits the generated camera tracking metadata to the background video generation device 34 through the communication unit 56.

After step 55, the processing returns to step S52, and the subsequent processes are repeated.

Since camera tracking metadata including the latest information regarding the position, the posture, and so forth of the shooting camera 11 can be acquired in such a manner as described above, the background video generation device 34 can render a background video only in the field of view of the shooting camera 11 as viewed from the latest position and posture of the shooting camera 11 (namely, a background video that serves as the inner frustum 21).

It is to be noted that, in order to execute rendering, it is necessary to acquire camera tracking metadata having a high degree of accuracy, and a pre-process described below is performed before shooting, in another information processing apparatus or the like.

### <Pre-Process>

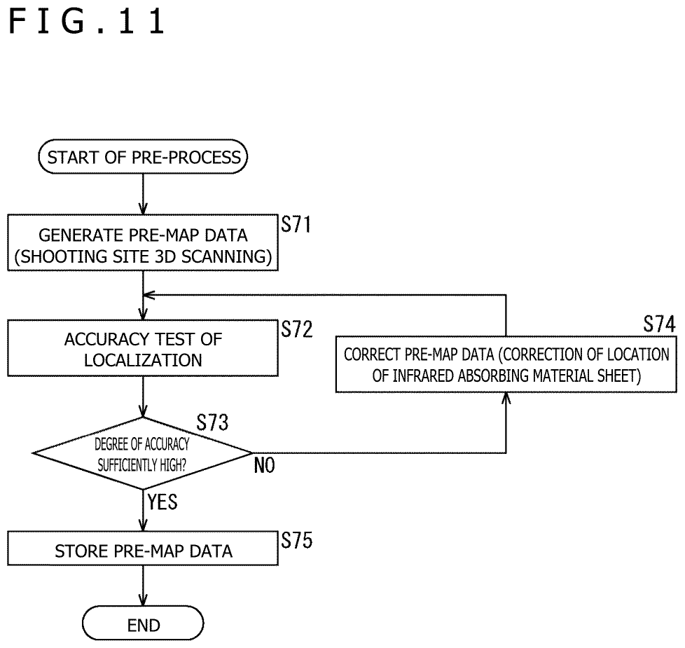

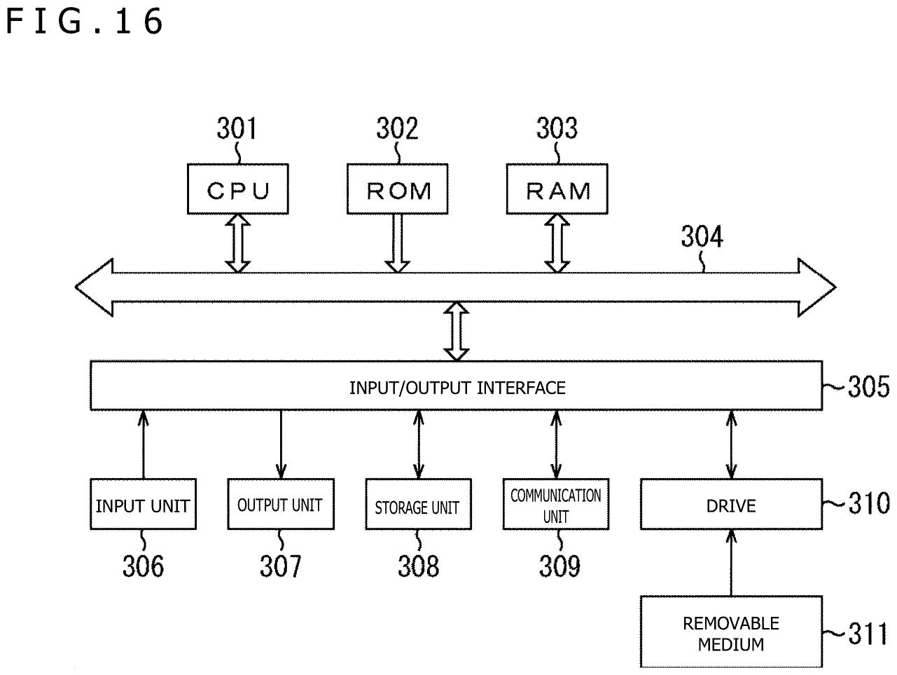

FIG. 11 is a flow chart illustrating a pre-process by another information processing apparatus. The other information processing apparatus includes, for example, a computer and the like of FIG. 16, to be described later. It is to be noted that the process of FIG. 11 may be performed by the processing unit 53 of the camera tracking device 32.

In step S71, the other information processing apparatus generates pre-map data with use of distance measurement data obtained, for example, from an unillustrated 3D scanner type three-dimensional measuring instrument as a result of 3D scanning in the shooting studio performed by the 3D scanner type three-dimensional measuring instrument. For the generation of the pre-map data, 3D scanning with a high degree of accuracy is required, and the 3D scanning for the generation of pre-map data is performed taking time.

On the LED display 12 in the shooting studio, for example, an infrared absorbing region 111 including four rectangular regions is arranged in a horizontal row as described hereinabove with reference to FIG. 8. Accordingly, for example, pre-map data is generated in which, no point cloud is present in regions of the LED display 12 corresponding to the four rectangular regions of the infrared absorbing region 111 while a point cloud is present in a region corresponding to a region other than the four rectangular regions.

In step S72, the other information processing apparatus performs an accuracy test by localization. In particular, the other information processing apparatus performs the localization process in steps S51 to S54 of FIG. 10 to acquire an estimation result of the self-position posture and calculates a degree of accuracy of the estimation result of the self-position posture.

Also in the input point cloud obtained by the LiDAR sensor 51, although the angle and so forth are different from those of the pre-map data, regarding the shape, matching can similarly be performed between the point cloud of the pre-map data and the input point cloud on the basis of the four rectangular regions in which no point cloud is present since no point cloud is present in regions of the LED display 12 corresponding to the four rectangular regions of the infrared absorbing region 111 and a point cloud is present in a region corresponding to the region other than the four rectangular regions.

In step S73, the other information processing apparatus determines whether or not the degree of accuracy of the calculated estimation result of the self-position posture is higher than a predetermined threshold value and the degree of accuracy is sufficiently high. In a case where it is determined in step S73 that the degree of accuracy of the calculated estimation result of the self-posture position is not sufficiently high, the processing advances to step S74.

In step S74, the other information processing apparatus corrects the pre-map data. In a case in which the degree of accuracy is not sufficiently high, it is considered that the position of an infrared absorbing region to which an infrared absorbing material sheet is pasted may not be suitable or the number of infrared absorbing regions may be small. Accordingly, the staff (user) will correct (change) the position or the number of infrared absorbing regions to which an infrared absorbing material sheet is to be pasted. Thereafter, 3D scanning in the shooting studio is performed again by the 3D scanner type three-dimensional measuring instrument and the pre-map data is corrected.

Thereafter, the processing returns to step S72, and the subsequent processes are repeated.

In a case where it is determined in step S73 that the degree of accuracy of the calculated estimation result of the self-posture position is sufficiently high, the processing advances to step S75.

In step S75, the other information processing apparatus transmits the pre-map data generated in the memory or the like to the camera tracking device 32 through a network or the like and stores the transmitted data into the storage 57 of the camera tracking device 32.

It is to be noted that, upon correction of the pre-map data in step S74, the location for an infrared absorbing material sheet may be determined after generation of the pre-map data. In this case, it is made unnecessary to perform re-3D scanning for map creation by using a point cloud editor or the like to perform such editing as to erase a point cloud in an infrared absorbing region in which an arranged infrared absorbing material sheet is to be pasted.

### <2. Modifications>

### <Modification of Arrangement Pattern of Infrared Absorbing Region>

Further, the arrangement pattern of an infrared absorbing region is not limited to the example of FIG. 8, and also some other arrangement patterns may be available.

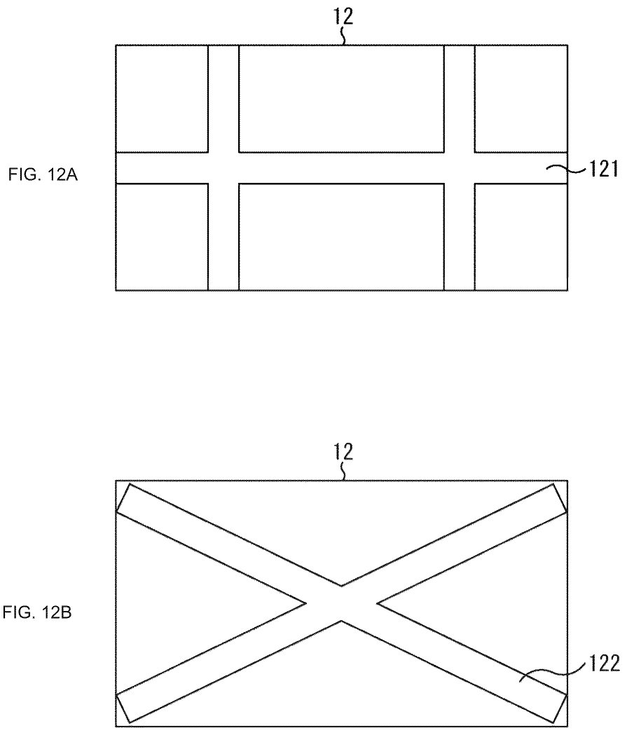

A and B of FIG. 12 are views depicting second and third examples of an arrangement pattern of an infrared absorbing region, respectively.

In A of FIG. 12, the second arrangement pattern is depicted in which an infrared absorbing region 121 including two vertical line regions and one horizontal line region is arranged in the LED display 12. It is to be noted that, in A of FIG. 12, the two vertical line regions and the one horizontal line region intersect with each other.

In B of FIG. 12, the third arrangement pattern is depicted in which an infrared absorbing region 122 including a diagonal line region from the upper left to the lower right and another diagonal line region from the upper right to the lower left is arranged in the LED display 12. It is to be noted that the two diagonal line regions in B of FIG. 12 intersect with each other at the center of the LED display 12.

As described above, an infrared absorbing material sheet is pasted to the region 92-n of each of the pixels 81-n included in the infrared absorbing regions 121 and 122.

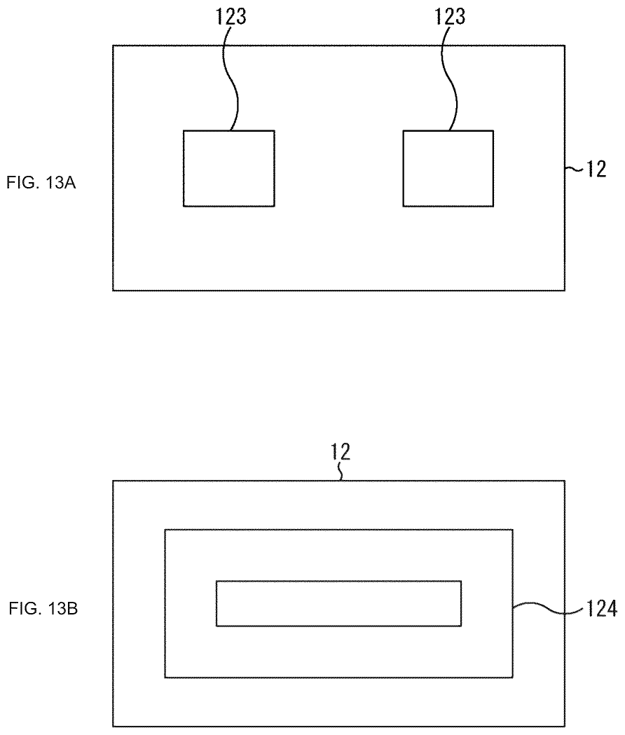

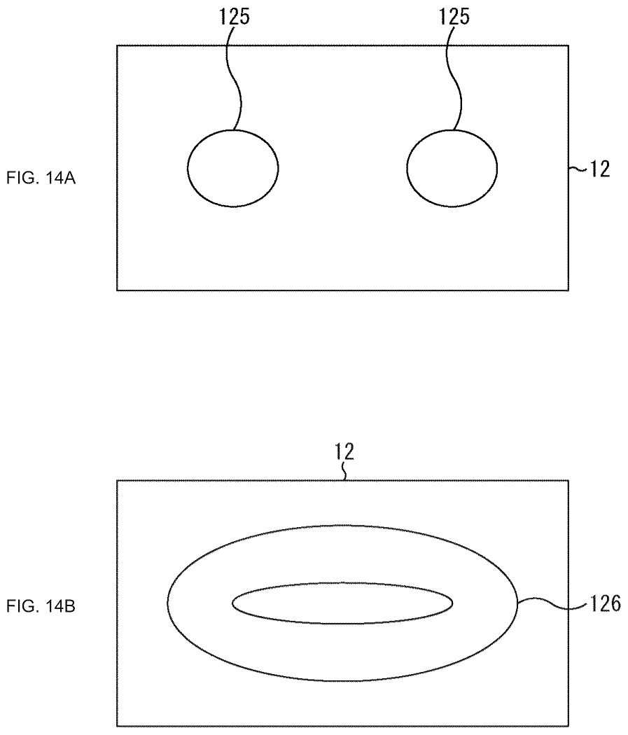

A and B of FIG. 13 are views depicting fourth and fifth examples of an arrangement pattern of an infrared absorbing region.

In A of FIG. 13, the fourth arrangement pattern is depicted in which an infrared absorbing region 123 including two square regions lined up horizontally is arranged in the LED display 12.

In B of FIG. 13, the fifth arrangement pattern is depicted in which a quadrangular frame-shaped infrared absorbing region 124 is arranged in the LED display 12.

As described above, an infrared absorbing material sheet is pasted to the region 92-n of each of the pixels 81-n included in the infrared absorbing regions 123 and 124.

A and B of FIG. 14 are views depicting sixth and seventh examples of an arrangement pattern of an infrared absorbing region.

In A of FIG. 14, the sixth arrangement pattern is depicted in which an infrared absorbing region 125 including two circular regions lined up horizontally is arranged in the LED display 12.

In B of FIG. 14, the seventh arrangement pattern is depicted in which a ring-shaped infrared absorbing region 126 is arranged in the LED display 12.

As described above, an infrared absorbing material sheet is pasted to the region 92-n of each of the pixels 81-n included in the infrared absorbing regions 125 and 126.

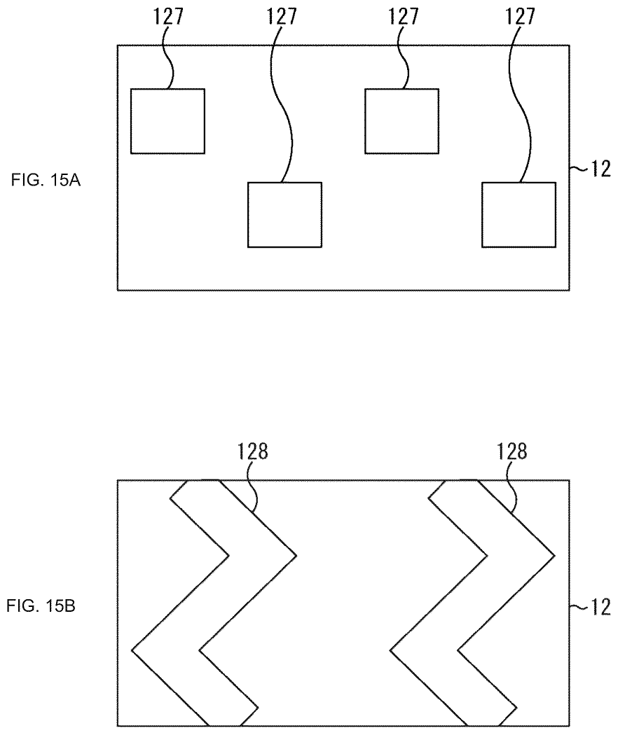

A and B of FIG. 15 are views depicting eighth and ninth arrangement patterns of an infrared absorbing region.

In A of FIG. 15, the eighth arrangement pattern is depicted in which an infrared absorbing region 127 including four square regions arranged in a zigzag pattern in two upper and lower stages is arranged in the LED display 12.

In B of FIG. 15, the ninth arrangement arrangement pattern is depicted in which an infrared absorbing region 128 including two zigzag regions lined up horizontally in two columns is depicted in the LED display 12.

As described above, an infrared absorbing material sheet is pasted to the region 92-n of each of the pixels 81-n included in the infrared absorbing regions 127 and 128.

It is to be noted that the examples in FIGS. 12 to 15 are examples of a case in which the resolution of the LiDAR sensor 51 is not very high, and in a case where the resolution of the LiDAR sensor 51 is high, a finer arrangement pattern may be used such that the arrangement pattern of any of FIGS. 12 to 15 is scaled down and repeated.

Further, the arrangement pattern of an infrared absorbing region is not limited to the examples in FIGS. 8 and 12 to 15 and may be an arrangement pattern including other designs.

With this configuration described above, since point cloud data acquired on the basis of the LiDAR sensor 51 includes point clouds other than the infrared absorbing region 111, even if there is no three-dimensional object for position posture estimation of the camera in the studio, localization can be performed simply and accurately.

It is to be noted that, although the foregoing description is directed to an example in which an infrared absorbing material sheet is pasted to the LED display 12 on the back side, in a case where it is necessary for pre-map data generation, an infrared absorbing material sheet may be pasted to an LED display provided on the ceiling or a side wall.

Further, although the present embodiment is described taking the virtual production system 1 as an example, also in a studio other than that for virtual production, namely, in an ordinary shooting studio, an infrared absorbing material sheet may be pasted or placed, for example, to or on a wall, the ceiling or the floor. Also in this case, the estimation accuracy of the position posture of the camera is improved similarly.

Furthermore, although the present embodiment is described assuming that a ray of light used in the LiDAR sensor 51 is an infrared ray, a ray of light of a wavelength other than an infrared ray may be used. In this case, an absorbing material sheet that absorbs light of a wavelength of a ray of light used in the LiDAR sensor 51 is used.

### <3. Others>

### <Advantageous Effect of Present Technology>

In the present technology, light of a predetermined wavelength is absorbed at a light absorbing region that is at least part of a region, other than a light source, of a light absorbing pixel that is at least part of a plurality pixels in which the light source is arranged.

This makes it possible to improve the estimation accuracy of a position posture of a camera that shoots a video to be displayed as a background.

### Example of Configuration of Computer

The series of processes described above not only can be executed by hardware but also can be executed by software. In a case where the series of processes is executed by software, a program that constitutes the software is installed into a computer incorporated in hardware for exclusive use, a general-purpose personal computer, or the like from a program recording medium.

FIG. 16 is a block diagram depicting an example of a hardware configuration of a computer that executes the series of processes described above according to a program.

A CPU 301, a ROM (Read Only Memory) 302, and a RAM 303 are connected to each other by a bus 304.

Further, an input/output interface 305 is connected to the bus 304. An Input unit 306 including a keyboard, a mouse, and so forth and an output unit 307 including a display, a speaker, and so forth are connected to the input/output interface 305. Further, a storage unit 308 including a hard disk, a nonvolatile memory, or the like, a communication unit 309 including a network interface and so forth, and a drive 310 that drives a removable medium 311 are connected to the input/output interface 305.

In the computer configured in such a manner as described above, the CPU 301 loads a program stored, for example, in the storage unit 308 into the RAM 303 through the input/output interface 305 and the bus 304 and executes the program to perform the series of processes described above.

The program to be executed by the CPU 301 is, for example, recorded on and provided as a removable medium 311 or is provided through a wire or wireless transmission medium such as a local area network, the Internet, or a digital broadcast, and is installed into the storage unit 308.

It is to be noted that the program to be executed by the computer may be a program by which the processes are performed in a time series in the order as described in the present specification or may be a program by which the processes are executed in parallel or executed individually at necessary timings such as when the process is called.

It is to be noted that, in the present specification, the system signifies an aggregation of a plurality of components (devices, modules (parts), and so forth), and it does not matter whether or not all components are accommodated in the same housing. Accordingly, both of a plurality of apparatuses accommodated in separate housings and connected to each other through a network and one apparatus in which a plurality of modules is accommodated in a single housing are systems.

Further, the advantageous effects described in the present specification are merely examples and are not limited, and other advantageous effects may be available. The embodiment of the present technology is not limited to the embodiment described above, and various alterations are possible without departing from the gist of the present technology.

For example, the present technology can assume a configuration for crowd computing in which one function is shared by a plurality of apparatuses through a network and processed in collaboration.

Further, the steps described above in connection with the flow charts not only can be executed by a single apparatus or but also can be shared and executed by a plurality of apparatuses.

Furthermore, in a case where one step includes a plurality of processes, the plurality of processes included in the one step not only can be executed by a single apparatus but also can be shared and executed by a plurality of apparatuses.

### <Example of Combination of Configurations

The present technology can assume such configurations as described below.

(1)

A video displaying apparatus including:
a plurality of pixels in each of which a light source is arranged, in which
light of a predetermined wavelength is absorbed at a light absorbing region that is at least part of a region, other than the light source, of a light absorbing pixel that is at least part of the plurality of pixels.
   (2)

The video displaying apparatus according to (1) above, in which
the light absorbing pixel includes a pixel included in a specific pixel region of the plurality of pixels.
   (3)

The video displaying apparatus according to (1) or (2) above, in which
the specific pixel region is changeable.
   (4)

The video displaying apparatus according to any one of (1) to (3) above, in which
the light absorbing region includes a region to which an absorbing material sheet that absorbs the light of the predetermined wavelength is pasted.
   (5)

The video displaying apparatus according to any one of (1) to (4) above, in which
the light of the predetermined wavelength includes infrared light.
   (6)

The video displaying apparatus according to any one of (1) to (5) above, in which
the light source includes an LED (Light Emitting Diode), and
the video displaying apparatus includes an LED display.
   (7)

A video processing system including:
a video displaying unit that includes a plurality of pixels in each of which a light source is arranged and that absorbs light of a predetermined wavelength at a light absorbing region that is at least part of a region, other than the light source, of a light absorbing pixel that is at least part of the plurality of pixels;
a camera that shoots a video to be displayed on the video displaying unit on a background;
a position posture estimation unit that estimates a position posture of the camera with use of distance measurement data acquired from a sensor; and
a video generation unit that generates, on the basis of a result of the estimation of the position posture, video data that associates the position of the camera in a real space and the position of the camera in the video with each other, to output the generated video data to the video displaying unit.
   (8)

The video processing system according to (7) above, in which
the light absorbing pixel includes a pixel included in a specific pixel region of the plurality of pixels.
   (9)

The video processing system according to (7) or (8) above, in which
the specific pixel region is changeable.
   (10)

The video processing system according to any one of (7) to (9) above, in which
the light absorbing region includes a region to which an absorbing material sheet that absorbs the light of the predetermined wavelength is pasted.
   (11)

The video processing system according to any one of (7) to (10) above, in which
the light of the predetermined wavelength includes infrared light.
   (12)

The video processing system according to any one of (7) to (11) above, in which
the sensor includes LiDAR (Light Detection And Ranging) that emits the light of the predetermined wavelength.
   (13)

The video processing system according to any one of (7) to (12) above, in which
the light source includes an LED), and
the video displaying unit includes an LED display.
   (14)

The video processing system according to any one of (7) to (13) above, in which
the position posture estimation unit estimates the position posture of the camera with use of map data generated in advance and the distance measurement data.
   (15)

A video processing method executed by a video processing system, including:
estimating a position posture of a camera shooting a video to be displayed on a video displaying unit on a background, with use of distance measurement data acquired from a sensor, the video displaying unit including a plurality of pixels in each of which a light source is arranged and absorbing light of a predetermined wavelength at a light absorbing region that is at least part of a region, other than the light source, of a light absorbing pixel that is at least part of the plurality of pixels; and
generating, on the basis of a result of the estimation of the position posture, video data that associates the position of the camera in a real space and the position of the camera in the video with each other, and outputting the generated video data to the video displaying unit.

### REFERENCE SIGNS LIST

1: Virtual production system
11: Shooting camera
12: LED display
21: Inner frustum
22: Outer frustum
31: Shot video processing device
32: Camera tracking device
33: Synchronizing signal generation device
34: Background video generation device
51: LiDAR sensor
52: Camera operation acquisition unit
53: Processing unit
54: Memory
55: Synchronizing signal acquisition unit
56: Communication unit
57: Storage
81-n: Pixel
91-n: LED light source
92-n: Region
101: Infrared absorbing material sheet
111, 121 to 129: Infrared absorbing region

1. A video displaying apparatus comprising:
a plurality of pixels in each of which a light source is arranged, wherein
light of a predetermined wavelength is absorbed at a light absorbing region that is at least part of a region, other than the light source, of a light absorbing pixel that is at least part of the plurality of pixels.

2. The video displaying apparatus according to claim 1, wherein
the light absorbing pixel includes a pixel included in a specific pixel region of the plurality of pixels.

3. The video displaying apparatus according to claim 2, wherein
the specific pixel region is changeable.

4. The video displaying apparatus according to claim 1, wherein
the light absorbing region includes a region to which an absorbing material sheet that absorbs the light of the predetermined wavelength is pasted.

5. The video displaying apparatus according to claim 1, wherein
the light of the predetermined wavelength includes infrared light.

6. The video displaying apparatus according to claim 1, wherein
the light source includes an LED (Light Emitting Diode), and
the video displaying apparatus includes an LED display.

7. A video processing system comprising:
a video displaying unit that includes a plurality of pixels in each of which a light source is arranged and that absorbs light of a predetermined wavelength at a light absorbing region that is at least part of a region, other than the light source, of a light absorbing pixel that is at least part of the plurality of pixels;
a camera that shoots a video to be displayed on the video displaying unit on a background;
a position posture estimation unit that estimates a position posture of the camera with use of distance measurement data acquired from a sensor; and
a video generation unit that generates, on a basis of a result of the estimation of the position posture, video data that associates the position of the camera in a real space and the position of the camera in the video with each other, to output the generated video data to the video displaying unit.

8. The video processing system according to claim 7, wherein
the light absorbing pixel includes a pixel included in a specific pixel region of the plurality of pixels.

9. The video processing system according to claim 8, wherein
the specific pixel region is changeable.

10. The video processing system according to claim 7, wherein
the light absorbing region includes a region to which an absorbing material sheet that absorbs the light of the predetermined wavelength is pasted.

11. The video processing system according to claim 7, wherein
the light of the predetermined wavelength includes infrared light.

12. The video processing system according to claim 7, wherein
the sensor includes LiDAR (Light Detection And Ranging) that emits the light of the predetermined wavelength.

13. The video processing system according to claim 7, wherein
the light source includes an LED), and
the video displaying unit includes an LED display.

14. The video processing system according to claim 7, wherein
the position posture estimation unit estimates the position posture of the camera with use of map data generated in advance and the distance measurement data.

15. A video processing method executed by a video processing system, comprising:
estimating a position posture of a camera shooting a video to be displayed on a video displaying unit on a background, with use of distance measurement data acquired from a sensor, the video displaying unit including a plurality of pixels in each of which a light source is arranged and absorbing light of a predetermined wavelength at a light absorbing region that is at least part of a region, other than the light source, of a light absorbing pixel that is at least part of the plurality of pixels; and
generating, on a basis of a result of the estimation of the position posture, video data that associates the position of the camera in a real space and the position of the camera in the video with each other, and outputting the generated video data to the video displaying unit.
